(19) United States
(12) Patent Application Publication
(10) Pub. No.: US 2013/0051858 A1
(43) Pub. Date: Feb. 28, 2013

(54) MOLD FOR RESIN SHAFT-END FLANGE AND ROLLER FOR IMAGE FORMING DEVICE INCLUDING THE RESIN SHAFT-END FLANGE PRODUCED BY THE MOLD

(71) Applicant: Yoshihiko Mukaiyama, Yokohama-shi (JP)

(72) Inventor: Yoshihiko Mukaiyama, Yokohama-shi (JP)

(73) Assignee: BRIDGESTONE CORPORATION, Chuo-ku, Tokyo (JP)

(21) Appl. No.: 13/638,444

(22) PCT Filed: Mar. 29, 2011
(86) PCT No.: PCT/JP2011/001877

§ 371 Date: Nov. 13, 2012

(30) Foreign Application Priority Data
Mar. 30, 2010 (JP) 2010-079346

(51) Int. Cl. G03G 9/00; B29C 45/37

(52) U.S. Cl. 399/222; 425/542

(57) ABSTRACT

A mold for producing a resin shaft-end flange for a roller for image forming devices, wherein the shaft-end flange includes a flange portion and a shaft portion projecting axially from the center axis of the flange portion and adapted to be fitted to an end portion of a metal sleeve of the roller. The mold (10) includes a flange-forming cavity (12) and a shaft-forming cavity (16) corresponding to the flange portion and the shaft portion of the shaft-end flange, respectively. The inner surface of the shaft-forming cavity is designed so that the shaft portion of the shaft-end flange has a sectional shape (16TP) with n^{th} order fold-axis symmetry, where “n” represents an integer not less than 2.

### TECHNICAL FIELD

The present invention relates to a technology for producing a resin shaft-end flange equipped at a shaft-end portion of various rollers such as a developing roller and a charging roller mounted in an image forming device, such as copier, printer, etc.

More particularly, the present invention relates to a mold for producing a resin shaft-end flange to be provided at both end portions of a hollow metal sleeve constituting a roller for image forming device, and also to a roller for image forming device including the resin shaft-end flange formed with the mold.

### BACKGROUND ART

Electrographic image forming devices, such as copier, printer, etc., includes a variety of rollers suitable for performing prescribed functions at different image forming process steps. As the basic design of such rollers, it is necessary to realize a high degree of axial accuracy and assure a smooth rotation when driven by the driving source. Thus, for instance, a solid metal rod is subjected to machining so as to highly accurately define the rotational center axis of the roller. In addition, the roller end portion (shaft-end portion) is generally provided with a so-called D-shaped cutout in order to readily position the roller while it is mounted in an image forming device, and also to positively transmit rotary force from the driving source (refer, for example, to Patent Documents 1 to 3 listed below).

In this way, it is possible to realize a roller with high degree of axial accuracy by subjecting a solid metal rod to machining. The D-shaped cutout at the shaft-end portion of the roller serves not only to facilitate the positioning while the roller is mounted in an image forming device, but also to achieve a smooth rotation of the roller by transmitting the driving force through a gear fitted to the D-shaped cutout. Moreover, the D-shaped cutout can be utilized for positioning and/or transmitting driving force, etc., also during the coating process where the main body of the roller is applied with a coating film

In recent years, there is an increasing demand in the relevant industry for products with further reduced weight, thickness and size, and such demand is also applicable to rollers for image forming devices. Thus, Patent Document 4 discloses a novel type of rollers, wherein a hollow metal sleeve is used as the main body of the roller and resin flange is arranged at each end of the metal sleeve for engagement with a driving source for rotating the roller.

Since the hollow metal sleeve of the roller as disclosed in Patent Document 4 includes a resin shaft-end flanges at each end, it is possible to reduce the weight and cost of the roller by saving the amount of metal to be used.

The resin shaft-end flange for rollers as described above can be conveniently produced by utilizing a mold, which is also advantageous in terms of cost. However, when a resin shaft-end flange including an unevenly shaped shaft portion is formed by using a mold, the shaft portion extending from the main flange portion of the resin shaft-end flange tends to cause inclination (so called “shaft inclination”). Although the mechanism giving rise to such shaft inclination is not clear, it is considered that, when resin material is injected into the mold, or when the resin material is cooled and solidified in the mold, internal stress occurs due to the uneven sectional shape or lack of rotational symmetry of the shaft, thereby causing shaft inclination to occur upon removal of the shaft-end flange from the mold. Obviously, it is not very desirable to apply a resin shaft-end flange with shaft-inclination to rollers for image forming devices.

The shaft inclination problem as noted above will be further explained below with reference to FIG. 4, which shows a roller 100 for image forming device including a hollow metal sleeve 101 fitted at both ends with resin shaft-end flanges 102 and 103.

The roller 100 as shown in FIG. 4 is provided with a D-shaped cutout at the tip end portion of a shaft portion 102a of the shaft-end flange 102 on one side (the left side in FIG. 4), so that shaft inclination tends to occur in the shaft portion 102a. If the shaft portion 102a of the roller 100 has shaft inclination, vibration tends to occur as the roller 100 supported by bearings 111 and 112 of a rotating device (shown herein only partly) is rotated, since the center axis 101CL of the metal sleeve 101 is not accurately aligned with the center axis 102CL of the shaft portion 102a.

Furthermore, there may be instances wherein the roller 100 for image forming devices as described above is subjected during the production process to painting on the outer periphery of the metal sleeve 101, e.g. for controlling the electrostatic property and/or protecting the surface.

FIG. 4 also illustrates schematically, by dotted lines, a discharging die 120 for painting an UV (ultraviolet) curing coating material on the surface of the metal sleeve 101, a regulating blade 121 for regulating the thickness of the coated film at a constant value, and a spot UV apparatus 122 for radiating UV ray and curing the coated film.

Under the conditions as shown in FIG. 4, when rotational vibration occurs due to shaft inclination, the thickness of the coated film becomes uneven, thereby degrading the accuracy of the uniformity of the paintings, and possibly resulting in that a clear image cannot be produced by the image forming device incorporating the roller with such insufficient accuracy of the painting. Furthermore, the image forming device incorporating a roller with shaft inclination may generate noise within the device, and also cause feeding error upon contact with the sheet material to be transferred.

### PATENT DOCUMENTS

Patent Document 1: JP 2000-315011A
Patent Document 2: JP 2000-35033A
Patent Document 3: JP 2002-304060A
Patent Document 4: JP 2008-151324A

### DISCLOSURE OF THE INVENTION

### Problem to be Solved by the Invention

In view of the above, it is an object of the present invention to provide a mold, which is highly suitable for forming a roller for image forming device, comprising a metal sleeve and a resin shaft-end flange fitted to an end of the metal sleeve, and which is capable of forming the resin shaft-end flange without shaft inclination. In addition, the present invention aims also to provide a highly reliable roller for image forming device without shaft inclination.

### Means for Solving the Problem

The object as noted above can be accomplished by means of a mold for producing a resin shaft-end flange according to the present invention.

More particularly, the present invention provides a mold for producing a resin shaft-end flange to be fitted to an end portion of a metal sleeve of a roller for an image forming device, wherein the resin shaft-end flange comprises a flange portion and a shaft portion projecting axially from a center axis of the flange portion. The mold comprises a flange-forming cavity for forming the flange portion of the shaft-end flange, and a shaft-forming cavity for forming the shaft portion of the shaft-end flange. The shaft-forming cavity comprises an inner surface designed to form the shaft portion of the shaft-end flange, having a sectional shape with n^{th} order fold-axis symmetry, where “n” represents an integer not less than 2.

It is preferred that the inner surface of the shaft-forming cavity is designed so that the shaft portion of the shaft-end flange has a polygonal cross-sectional shape with a plurality of sides, the number of which sides being a multiple of 3.

The present invention further provides a roller for image forming devices, wherein at least one resin shaft-end flange produced by the mold as described above is fitted to at least one end of a metal sleeve.

### Effects of the Invention

The mold according to the present invention has an inner surface that serves to form a shaft portion of the shaft-end flange with a sectional shape of n^{th} order fold-axis symmetry about the center axis, where “n” is an integer not less than 2. Due to such fold-axis symmetry, the resin material injected into the mold can be uniformly throughout the entire cavity of the mold. By this, even when internal stress occurs during subsequent hardening of the resin, the internal stress can be effectively equalized. Moreover, by adopting the resin shaft-end flange produced by the mold according to the present invention, it is possible to realize a highly reliable roller for image forming devices, with an improved alignment in terms of the center axes of the sleeve portion and the flange portion.

### BRIEF DESCRIPTION OF THE DRAWINGS

FIG. 1 is a longitudinal-sectional view showing a roller for image forming devices, including resin shaft-end flanges produced by a mold according to the present invention.

FIG. 2(a) is a sectional view of a mold for producing a resin shaft-end flange.

FIG. 2(b) is a view as seen in the direction of arrows b-b in FIG. 2(a).

FIGS. 3(a) to 3(c) show modified examples of the cross-sectional shape of the shaft portion.

FIG. 4 is a longitudinal-sectional view of a roller for image forming devices, for explaining the problem of the prior art.

### BEST MODE FOR CARRYING OUT THE INVENTION

One embodiment of the present invention will be described below in detail, with reference to the drawings. In order to facilitate understandings of the present invention, a brief explanation is made of a roller for image forming device, which includes a resin shaft-end flange produced by a mold according to the present invention.

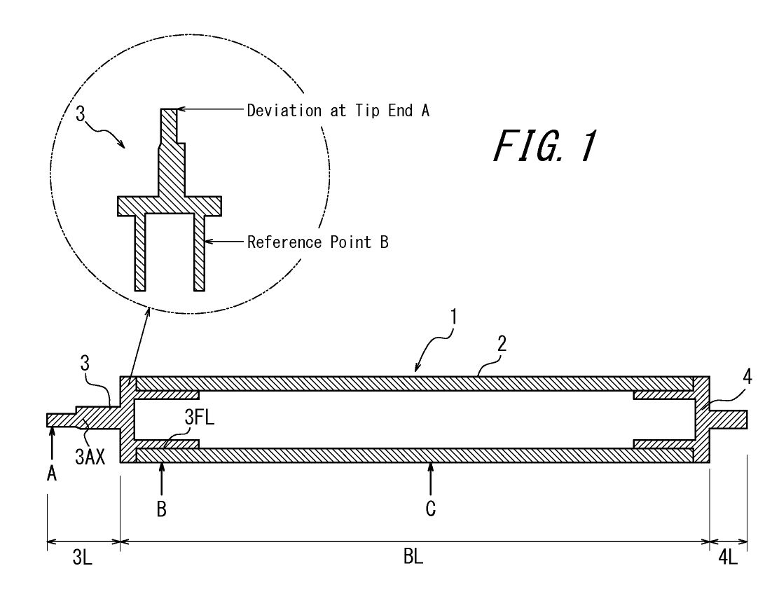

FIG. 1 shows a roller 1 for image forming devices, wherein a resin shaft-end flange produced by a mold according to the present invention is arranged at one end (the left end in FIG. 1) of the roller. The roller 1 includes a cylindrical metal sleeve 2 and resin shaft-end flanges 3, 4 fitted to the openings at both ends of the metal sleeve 2. In the roller 1 of FIG. 1, a resin shaft-end flange 3 produced by the mold according to the present invention is equipped as the left resin shaft-end flange 3.

Here, the metal sleeve 2 may comprise aluminum, steel, etc. Further, the material for the resin shaft-end flanges 3, 4 mat be selected suitably from versatile resins or engineering plastics. It is desirable to choose a resin material that can be easily formed by injection molding process, etc.

More particularly, engineering plastics suitable for the resin shaft-end flange include polyacetal, polyamide resins (such as polyamide 6, polyamide 6.6, polyamide 12, polyamide 4.6, polyamide 6.10, polyamide 6.12, polyamide 11, polyamide MXD6-polyamide produced by Meta-xylenediamine and adipic acid, etc.), polyoxymethylene (POM), polybutyleneterephthalate, polyphenyleneoxide, polyphenyleneether, polyphenylenesulfide, polyethersulfon, polycarbonate, polyimide, polyamidimide, polyetherimide, polysulfone, polyetheretherketone, polyethylenetelephthalate, polyarylate, liquid crystal polymer, polytetrafluoroethylene, etc. Furthermore, suitable versatile resins include polypropylene, acrylonitrile-butadiene-styrene (ABS) copolymer, polystyrene, polyethylene, etc. Besides, there may be used melamine resin, phenol resin, silicone resin, etc., either alone or in combination.

Among others, engineering plastics are preferred as the resin material, and the following resins are particularly preferred due to excellent formability as a result of thermal plasticity, and also due to superior mechanical strength: polyacetal, polyamide resin, polybutyleneterephthalate, polyphenyleneether, polyphenylenesulfide, polycarbonate, etc. In particular, the most preferable resin materials are polyamide 6.6, polyamide MXD6, polyamide 6.12, polybutyleneterephthalate, or mixture thereof.

As conducting agent for providing electrical conductivity for the resin shaft-end flange, various agents may be used as long as they can be homogeneously dispersed in the resin material. More particularly, it is preferred to use the following powder conducting agents: carbon black powder, graphite powder, carbon fiber, metal powders such as aluminum, copper and nickel, metal-oxide powders such as tin oxide, titanic oxide and zinc oxide and conducting glass powder, either alone or in combination.

The resin shaft-end flange 3 (the left side flange in FIG. 1) of the roller 1 is essentially same as the prior art shaft-end flange in the basic structure as explained above, though the shaft-end flange 3 is characterized in that it has been produced by the mold to be described hereafter.

The resin shaft-end flange 3 comprises a flange portion 3FL, which is partly fitted into the metal sleeve 2, and a shaft portion 3AX projecting axially from the shaft portion along its center axis. More particularly, the flange portion 3FL includes a cylindrical fitting portion, having an outer diameter approximately same as the inner diameter of the metal sleeve 2 and fitted with the inner periphery of the metal sleeve 2, and a closure disc at one end of the fitting portion for closing the end of the metal sleeve 2, when the fitting portion is fitted into the metal sleeve 2. The shaft portion 3AX projects axially from the center of the closure disc, in a direction opposite to the fitting portion.

Here, the shaft portion 3AX has its tip end side provided with cutout in basically the same manner as in the prior art roller. However, unlike the conventional D-shaped cutout, the sectional shape of the shaft portion 3AX has an n^{th} order fold-axis symmetry about the center axis (where “n” is an integer not less than to 2), to thereby prevent the shaft portion 3AX from undergoing inclination as explained above, when the resin material is injected into the mold for producing the resin shaft-end flange 3.

As used herein, the term “fold-axis symmetry” means that the sectional shape after rotating a shaft portion about a center axis is the same as the initial shape before the rotation. For instance, the term “2^{nd} order fold-axis symmetry” means that the sectional shape of the shaft portion after it has been rotated by 180 degrees is same as the initial shape before the rotation. Similarly, the 3^{rd} order fold-axis symmetry means that the sectional shape after 120 degrees rotation is same as the initial shape, and the 4^{th} order fold-axis symmetry means that the sectional shape after 90 degrees rotation is same as the initial shape.

In the prior art, the shaft portion is provided with a D-shaped cutout for facilitating the positioning and positively transmitting drive force, when the outer periphery of the sleeve is painted during production of the roller, or when the roller is mounted in an image forming device. Thus, the fitting portions of the conventional image forming device and the conventional painting equipment, both to be engaged with the shaft portion of the prior art roller, are of a shape (D-shape) corresponding to the D-shaped cutout of the prior art roller. In order to utilize existing image forming device and painting equipment without any design changes, it is necessary for the fitting portions of the image forming device and the painting equipment to be compatible with the fold-axis symmetry at the tip end side of the shaft portion 3AX of the resin shaft-end flange 3. With regard to such requirement, however, any special consideration would be unnecessary if, in accordance with the present invention, the tip of the shaft portion 3AX is designed to have a plurality of D-shaped cutouts for realizing fold-axis symmetry.

Namely, two D-shaped cutouts are arranged for realizing a 2^{nd} order fold-axis symmetry, and three D-shaped cutouts are arranged for realizing a 3^{rd} order fold-axis symmetry, among which one of the D-shaped cutouts may be fitted into the fitting portion of the painting equipment or the image forming device. In this arrangement, it is unnecessary to change the fitting portions of the existing painting equipment and image forming device, where the prior art roller for image forming devices had been mounted.

By adopting the resin shaft-end flange as described above, the cutouts in the shaft portion 3AX having a fold-axis symmetry serve to prevent the shaft portion 3AX from inclination as stated above, for the reasons to be explained below. The inventor assumed that an uneven cross section of the shaft portion caused the axis inclination in a prior art roller for image forming devices. Although the mechanism giving rise to such shaft inclination is not clarified, it has been considered that, when the cross section of the shaft portion is uneven, it is difficult to control the flowability of the thermoplastic resin materials injected into a mold, and the internal stress distribution becomes uneven when the resin materials are cooled and solidified.

In consideration of the above, the inventor found that the arrangement of cutouts in the shaft portion with a fold-axis symmetry could effectively prevent inclination of the shaft portions even when the flange is formed of resin by using a mold, and arrived at the present invention. In the prior art, a single D-shaped cutout has been considered already enough in order to be fitted with the painting equipment or the image forming device. However, the inventor confirmed that an uneven cross section (lack of fold-axis symmetry) of the shaft portion is disadvantageous for the resin shaft-end flange to be produced by using a mold, and the present invention is based on such findings.

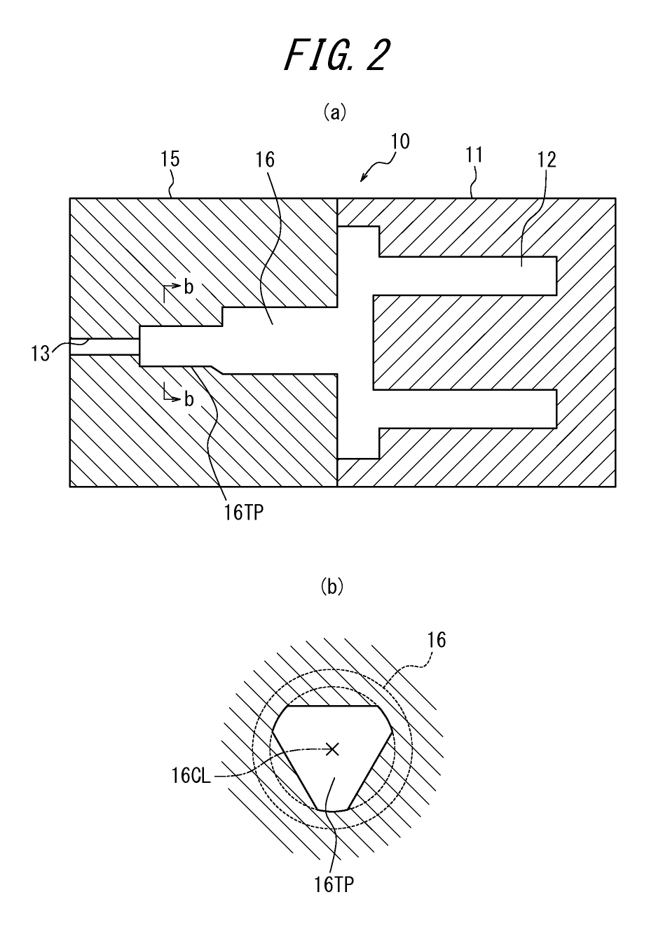

FIGS. 2(a) and 2(b) show the details of a mold for producing the above mentioned resin shaft-end flange as one embodiment of the present invention, wherein FIG. 2(a) is a sectional view of a mold for producing a resin shaft-end flange and FIG. 2(b) is a view as seen in the direction of arrows b-b in FIG. 2(a).

The mold for the resin shaft-end flange 10 includes a flange-forming mold part 11 defining a flange-forming cavity 12 and a shaft-forming mold part 15 defining a shaft-forming cavity 16, which are arranged adjacent to each other. A resin injection gate 13 is formed in the shaft-forming mold part 15.

The flange-forming cavity 12 has a concave inner surface designed to form a main body of the flange portion 3FL to be fitted partly into the metal sleeve 2. More particularly, the flange-forming cavity 12 includes a cylindrical concave space with an outer diameter that is substantially same as the inner diameter of the metal sleeve 2, and a disc-shaped concave space at one end of the cylindrical concave space (i.e., at the connecting surface side with the shaft-forming mold 15), wherein the disc-shaped concave space has a diameter that is substantially same as the outer diameter of the metal sleeve 2.

Similarly, the shaft-forming cavity 16 has a concave inner surface that is designed to form the shaft portion projecting axially along a center axis of the flange portion 3FL. More particularly, the shaft-forming cavity 16 includes a cylindrical concave space formed at the connecting surface side with the flange-forming mold 11, and a concave space arranged at the tip end (on the left side in FIG. 2) of the cylindrical concave space and having a cross section with an n^{th} order fold-axis symmetry in a plane intersecting the center axis at right angles. The concave space having the n^{th} fold-axis symmetry is connected with the resin injection gate 13.

Thus, the inner surface of the tip end portion 16TP of the shaft-forming cavity is designed so that the resin materials injected therein forms a shaft portion with a sectional shape having an n^{th} order fold-axis symmetry about the center axis, where “n” is an integer not less than to 2.

FIG. 2(b) shows an arrangement where the shaft portion is formed so as to realize 3^{rd} order fold-axis symmetry about the center axis 16CL. In this way, if the mold is designed so as to form the cutouts of the shaft portion with a fold-axis symmetry about the center axis, as shown in the drawing, the resin materials can be injected equally from the resin injection gate 13 and the internal stresses can be equalized as they occur during the subsequent hardening of the resin materials, thereby making it possible to produce the resin shaft-end flange without shaft inclination.

In other words, by means of the mold as shown in FIGS. 2(a) and 2(b), having a shaft-forming cavity with an inner surface allowing formation of the cross section with n^{th} order fold-axis symmetry about the center axis, where “n” is an integer not less than to 2, it is possible to produce the resin shaft-end flange without shaft inclination. Thus, the resin shaft-end flange produced by the mold includes a shaft portion of a shape that corresponding to the shape of the shaft-forming cavity, namely a shaft portion of a shape with the n^{th} order fold-axis symmetry.

It would be sufficient for the shaft-forming cavity to be designed so that the tip end of the shaft portion formed by the shaft-forming cavity has a sectional shape with an n^{th} order fold-axis symmetry about the center axis. For instance, in the case of 2^{nd} order fold-axis symmetry, the same shape is retained before and after rotation by 180 degrees and, in the case of 4^{th} order fold-axis symmetry, the same shape is retained before and after rotation by 90 degrees. It is particularly preferred that the polygonal cross-sectional shape of the shaft portion has a plurality of sides, the number “n” of which is a multiple of 3, i.e. triangle for n=3, hexagon for n=6, and nonagon for n=9.

However, if the number n of the order is increased, the cross section of the shaft portion approaches a circle. Given that the purpose of the D-shaped cutout is to facilitate a correct positioning of the roller for image forming devices and to positively transmit the driving force, it is preferred that a relatively long side be arranged in order to allow a relatively long margin to be contacted with, and fitted into, the fitting portions of the image forming device and painting equipment. For such consideration, as shown in FIG. 2(b), it is preferred that the cross sectional shape of the shaft portion is triangular (i.e., three surfaces of D-shaped cutouts).

As used herein, the term “polygonal cross-sectional shape” includes a shape with rounded corners as shown in FIG. 2(b).

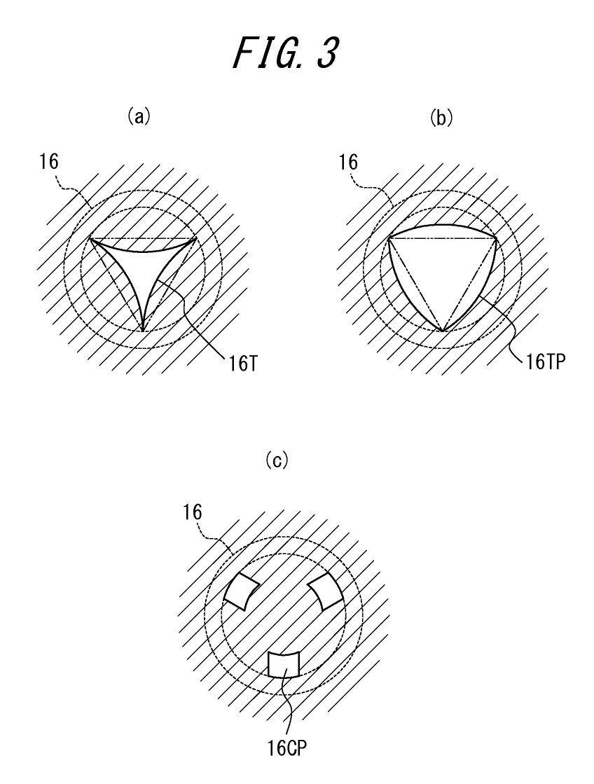

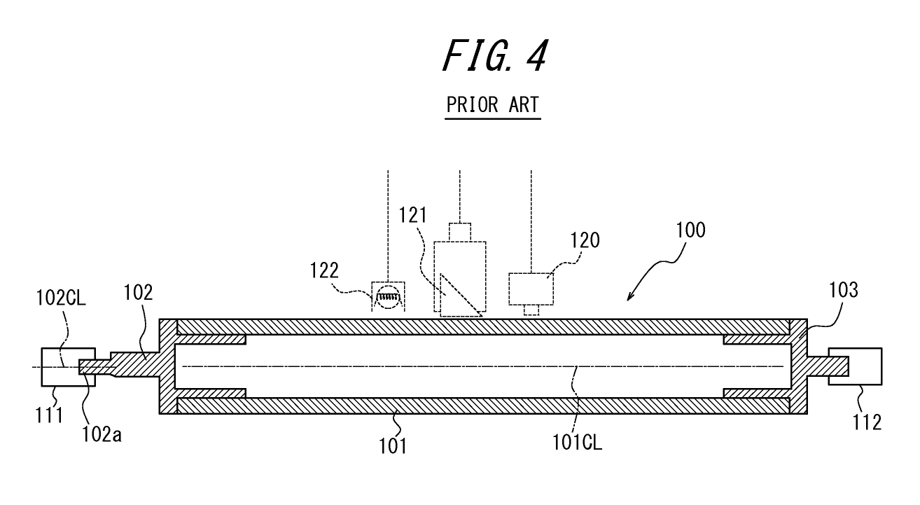

Modified embodiments in terms of the sectional shape of the shaft portion are shown in FIGS. 3(a) to 3(c). It is not necessarily required that the sectional shape is in a polygonal cross-sectional shape formed by straight lines; the sectional shape may be changed into a polygon defined by curved lines. In this instance also, it is preferred that the 3^{rd} order fold-axis symmetry (n=3) is applied as shown.

FIG. 3(a) shows a modification, wherein the tip end portion 16TP of the cavity on the side of the shaft-forming cavity 15 has a basic triangle shape of which the straight sides are changed to inwardly convex sides. FIG. 3(b) another modification, wherein the tip end portion 16TP of the cavity on the side of the shaft-forming cavity 15 has a basic triangle shape of which the straight sides are changed to outwardly convex sides. Finally, FIG. 3(c) shows still another modification, wherein three groove-like concave portions 16CP are arranged at an angular interval of 120 degrees in the circumferential direction for realizing fold-axis symmetry. However, for adopting the shapes shown in FIGS. 3(a) to 3(b), it may be necessary to modify the fitting portions of the painting equipment and/or the image forming device accordingly.

The resin shaft-end flange 4 fitted to another end of the roller (the right end in FIG. 1) may be formed with a prior art mold including a simply formed cavity without cutouts in the shaft portion.

It is noted that, in the roller 1 according to the embodiments described above, the n^{th} order fold-axis symmetry is applied only to the resin shaft-end flange 3 to be fitted into the fitting portion on the driving source side of the image forming device or painting equipment. However, the roller according to the present invention may be designed so that the resin shaft-end flange on the other side also comprises the shaft portion having a sectional shape of n^{th} order fold-axis symmetry about the center axis.

### EXAMPLES

Test rollers were prepared by producing resin shaft-end flanges by the mold as shown in FIG. 2, which were then fitted to the ends of the roller (see, FIG. 1). The roller includes a metal sleeve made of aluminum (aluminum A6063 by Nippon Light Metal Co. Ltd.), in which the resin shaft-end flanges were fitted at both ends. An electrically conducting material (EB-10 made by Polyplastics Co., Ltd.) was used as the thermoplastic resin forming the resin shaft-end flanges. The metal sleeve and the resin shaft-end flanges were bonded to each other by an adhesive (Loctite 430™ by Henkel Corp.)

As shown in FIG. 1, the rollers were formed to have the following dimensions: 230 mm in total length BL of the main body including the metal sleeve 2 and the flange portion 3FL of the resin shaft-end flange 3; 30 mm in shaft length 3L of the shaft portion 3AX projecting from the flange portion 3FL of the resin shaft-end flange 3; and 15 mm in shaft length 4L projecting from the flange portion of the resin shaft-end flange 4 in the opposite side.

Seven test rollers (embodiment rollers) were prepared, which are fitted with the resin shaft-end flanges produced by the mold shown in FIG. 2. For the purpose of comparison, seven test rollers (comparative rollers) were also prepared, which are fitted with the prior art resin shaft-end flanges having a single D-shaped cutout, and which are otherwise same as the embodiment test rollers. As shown by a circle in FIG. 1, the tip end A of the shaft portion A undergoes deviation relative to a reference point B in a region pressed into the sleeve 2, and this deviation was measured.

Here, as described in FIG. 1, deviation of at the tip end point A relative to the reference point B was measured as the deviation of the resin shaft-end flange 3 alone. In this measurement, the deviation (concentricity degree) of at the tip end point A relative to the reference point B was measured in mm by means of a roundness measuring gauge, Londcom 41A made by Tokyo Seimitsu Co., Ltd.

Also, deviation at the longitudinal center point C of the main body (metal sleeve 2) was measured while rotating the test rollers with the shaft portions supported at both ends by two bearings of 24 mm in diameter (φ) using a laser deviation checker, LSM-6000 made by Mitsutoyo Corp.

Images formed by the image forming devices equipped with each test roller were evaluated. The evaluation was made by classifying the printed images in accordance with different categories of the image irregularities, as represented by the following symbols:

“∘” Without image irregularities

“Δ” Some image irregularities recognized

“x” Obvious image irregularities recognized

Furthermore, rotation noise was evaluated also, as represented by the following symbols:

“∘” No noise generated

“x” Noise generated

Table 1 below shows the evaluation results of seven embodiment rollers and seven comparative rollers.

TABLE 1

| | | | |
|---|---|---|---|
| Tip end | Main body | | |
| deviation (mm) | radial run-out (mm) | Evaluation | Rotation noise |

COMPARATIVE ROLLERS(single D-shaped cutout)

| | | | |
|---|---|---|---|
| 0.038 | 0.046 | ∘ | x |
| 0.042 | 0.043 | Δ | x |
| 0.048 | 0.062 | Δ | x |
| 0.036 | 0.048 | ∘ | x |
| 0.052 | 0.058 | x | x |
| 0.064 | 0.078 | x | x |
| 0.058 | 0.068 | x | x |

EMBODIMENT ROLLERS(cutouts with 3^{rd} order fold axis symmetry)

| | | | |
|---|---|---|---|
| 0.018 | 0.024 | ∘ | ∘ |
| 0.014 | 0.022 | ∘ | ∘ |
| 0.020 | 0.032 | ∘ | ∘ |
| 0.016 | 0.028 | ∘ | ∘ |
| 0.024 | 0.042 | ∘ | ∘ |
| 0.018 | 0.036 | ∘ | ∘ |
| 0.016 | 0.024 | ∘ | ∘ |

It will be appreciated from the foregoing description that the mold according to the present invention makes it possible to effectively produce the resin shaft-end flange while preventing undesired shaft inclination. In the roller for image forming device comprising such a resin shaft-end flange, the center axes of the sleeve portion and the flange portion are aligned with each other. Thus, it is possible to provide a reliable roller capable of producing a clear image without irregularities and without noise generation.

In addition, the roller for image forming devices configured as described above allows a uniform coating film to be applied during the painting process, thereby contributing to production of a clear image in this respect as well.

### INDUSTRIAL APPLICABILITY

The present invention provides a mold which is highly suitable for a roller for image forming devices, comprising a metal sleeve and resin shaft-end flanges fitted to both ends thereof. The mold according to the present invention serves to effectively produce the resin shaft-end flange without shaft inclination. Moreover, the present invention allows a roller for image forming device to be produced without shaft inclination.

### REFERENCE NUMERALS

1: Roller for image forming device
2: Metal sleeve
3, 4: Resin shaft-end flange
10: Mold
12: Flange-forming cavity
16: Shaft-forming cavity

1. A mold for producing a resin shaft-end flange to be fitted to an end portion of a metal sleeve of a roller for image forming device, the shaft-end flange comprising a flange portion and a shaft portion projecting axially from a center axis of the flange portion, wherein:
the mold comprises a flange-forming cavity for forming the flange portion of the shaft-end flange, and a shaft-forming cavity for forming the shaft portion of the shaft-end flange; and
the shaft-forming cavity comprises an inner surface designed to form the shaft portion of the shaft-end flange, having a sectional shape with n^{th} order fold-axis symmetry, where “n” represents an integer not less than 2.

2. A mold according to claim 1, wherein the inner surface of the shaft-forming cavity is designed so that the shaft portion of the shaft-end flange has a polygonal cross-sectional shape with a plurality of sides, the number of said sides being a multiple of 3.

3. A roller for image forming device, said roller comprising at least one resin shaft-end flange formed by the mold according to claim 1 or 2.
